(19) United States
(12) Patent Application Publication
(10) Pub. No.: US 2017/0217033 A1
(43) Pub. Date: Aug. 3, 2017

(54) RAZOR CARTRIDGES

(71) Applicant: SHAVELOGIC, INC., Dallas, TX (US)

(72) Inventors: William E. Tucker, Attleboro, MA (US); Douglas R. Kohring, Arrowsic, ME (US); John W. Griffin, Moultonborough, NH (US); Craig A. Provost, Boston, MA (US)

(21) Appl. No.: 15/501,266

(22) PCT Filed: Aug. 11, 2015
(86) PCT No.: PCT/US15/44670

§ 371 Date: Feb. 2, 2017

Related U.S. Application Data
(60) Provisional application No. 62/039,569, filed on Aug. 20, 2014.

(51) Int. Cl. B26B 21/40; B26B 21/44

(52) U.S. Cl. CPC B26B 21/4031; B26B 21/443

(57) ABSTRACT

Replaceable shaving assemblies are disclosed that include a razor cartridge having a lubricating strip geometry that is designed to work with the blade geometry and other cartridge features to provide a close, comfortable shave over the intended lifetime of the cartridge. Shaving systems including such shaving assemblies are also disclosed, as are methods of using such shaving systems and methods of manufacturing these cartridges.

### BACKGROUND

Shaving systems often consist of a handle and a cartridge in which one or more blades are mounted in a plastic housing.

Most modern razor cartridges include a plurality of razor blades disposed between a guard and a cap. The cutting edge of each razor blade is positioned adjacent to a plane that tangentially intersects the contact surfaces of the guard and the cap. This plane, referred to as the “contact plane,” represents the theoretical position of the surface being shaved. The position of a razor blade's cutting edge relative to the contact plane is described in terms of the “exposure” of the cutting edge. A cutting edge with “positive exposure” is one that extends through the contact plane and into the area normally occupied by the object being shaved. A cutting edge with “negative exposure” is one that is positioned below the plane and therefore does not intersect the contact plane. A cutting edge with “neutral exposure” is one that is contiguous with the contact plane. Generally, positioning the cutting edge of a blade at a positive exposure has been found to improve closeness, but potentially also increases the chance of skin irritation. On the other hand, neutral or negative blade exposure tends to reduce the likelihood of irritation, but also tends to decrease the closeness of the shave.

The overall blade geometry of the cartridge, including blade exposure and other factors such as blade span, affects the comfort and closeness of the shave obtained with the razor, as well as the likelihood of nicks and cuts during shaving. Comfort and closeness is also impacted by “skin management,” i.e., the way in which the skin bulge contacted by the blade edges is affected by other elements of the razor.

For example, shaving comfort and efficacy can also be affected by providing a lubricating strip adjacent the cap, as is generally well known. Such lubricating strips typically exude lubricants, such as polyethylene oxide, from a polymer matrix that normally remains relatively intact throughout the operational life of the razor. The lubricant exuded from the plastic matrix allows the razor blade to glide with greater ease along the surface of the user's skin, thereby reducing the drag of the razor on the skin.

### SUMMARY

In general, the present disclosure pertains to razor cartridges, and to shaving assemblies that include such cartridges. The razor cartridges disclosed herein include lubricating strips having a geometry, and in some cases a composition, that enhances shaving comfort and efficacy during the lifetime of the cartridge.

In one aspect, the invention features a shaving assembly comprising an interface element configured to be mounted on a razor handle, and, pivotably mounted on the interface element, a razor cartridge. The razor cartridge includes (a) a frame defining a base, said frame having an opening defined in part by a composite guard having a leading guard surface and a cap having a trailing cap surface, said leading guard surface and said trailing cap surface cooperating to define a contact plane tangential thereto and extending across said opening; (b) a plurality of razor blades attached to said base; and (c) a lubricating strip mounted on the opposite side of the cap from the blades, the lubricating strip being configured so that contact is maintained between the user's skin and the trailing cap surface until the lubricating strip has worn to an extent that a trailing edge of the lubricating strip is positioned below the contact plane.

Some implementations include one or more of the following features. The lubricating strip may have an upper surface that extends at an angle with respect to the contact plane. The upper surface may extend above the contact plane. The cartridge may have a pivot point that is closer to the trailing cap surface than to the leading guard surface. An upper surface of the lubricating strip may be disposed at an angle with respect to the contact plane such that the forces between the skin and the lubricating strip surface are at an acute angle with respect to the contact plane. The lubricating strip may be configured such that the forces are at an angle of about 30 to 90 degrees with respect to the contact plane. The lubricating strip may be configured such an initial (pre-use) angle of the lubricating strip surface with respect to the contact plane is preferably from about 0 to 45 degrees.

In some implementations, an upper surface of the lubricating strip may be curved, e.g., the profile of an upper surface of the lubricating strip may be in the form of a generally symmetrical arc.

The height above the contact plane of the highest portion of the lubricating strip may be at least 25% of the height above the contact plane of the housing adjacent the lubricating strip, e.g., from about 25 to 100%, or at least 50% of the height above the contact plane of the housing adjacent the lubricating strip or even substantially equal to the height above the contact plane of the housing adjacent the lubricating strip.

In some cases, the shaving assembly further comprises a wear indicator positioned within the lubricating strip, which may comprise material having a different color from that of the lubricating strip. An indicating surface of the wear indicator may be generally coplanar with or parallel to the contact plane. In some cases the indicating surface is above and coplanar with the contact plane.

In another aspect, the invention features a razor comprising a handle having a distal end, an interface element configured to be mounted on the distal end of the handle, and, pivotably mounted on the interface element, a razor cartridge. The razor cartridge may include any of the features described above or elsewhere herein.

In other aspects, the invention features methods of contacting the skin with the razor cartridges described herein, and methods of manufacturing razor cartridges.

### DESCRIPTION OF THE DRAWINGS

FIG. 1 is a perspective view of a razor cartridge according to one implementation.

FIG. 1A is a rear perspective view of the razor cartridge of FIG. 1 mounted in a shaving assembly disposed on a handle.

FIG. 2 is an enlarged isometric cross-sectional view of a portion of the razor cartridge shown in FIG. 1.

FIG. 3 is an enlarged cross-sectional view of a portion of the razor cartridge showing details of the blade geometry.

FIG. 4 is a cross-sectional view of the cartridge with the cartridge pivot point indicated.

FIG. 5 is a perspective view of a razor cartridge according to an alternate embodiment.

FIG. 6 is an enlarged cross-sectional view of a portion of the razor cartridge shown in FIG. 5.

FIG. 7 is a perspective view of a razor cartridge according to another alternate embodiment.

FIGS. 8 and 8A are enlarged cross-sectional views of the razor cartridge shown in FIG. 7.

FIGS. 9 and 9A are, respectively, an isometric cross-sectional view and a cross-sectional view of a razor having a lubricating strip that includes a wear indicator.

### DETAILED DESCRIPTION

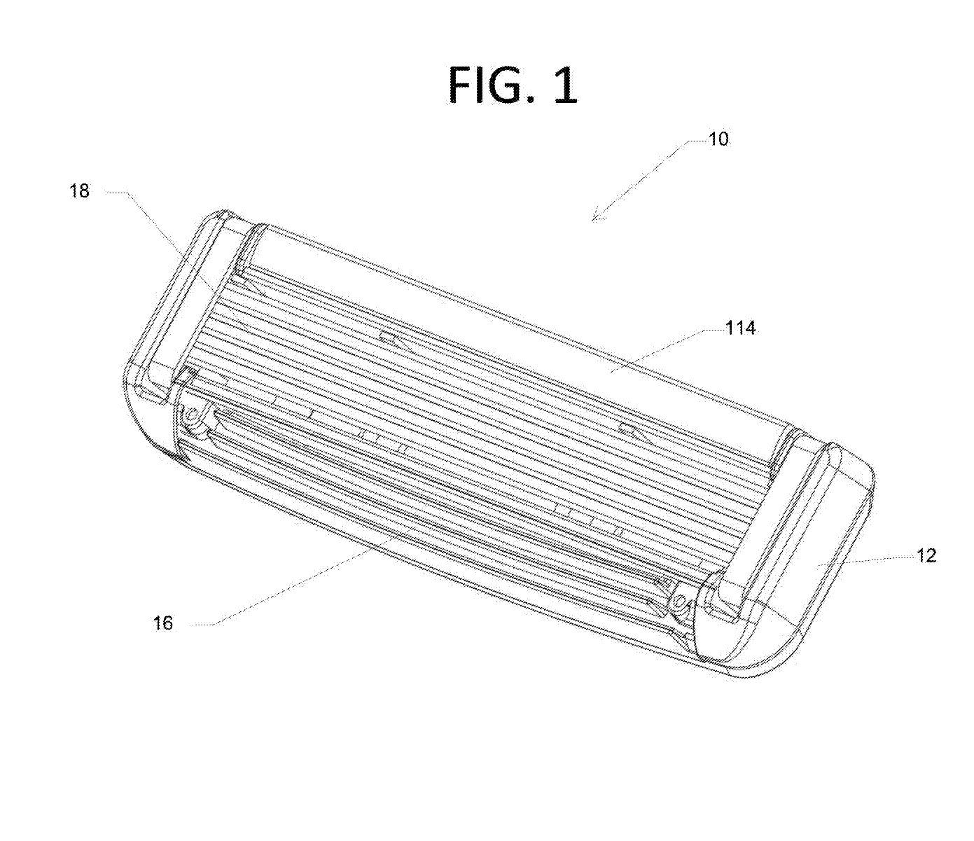

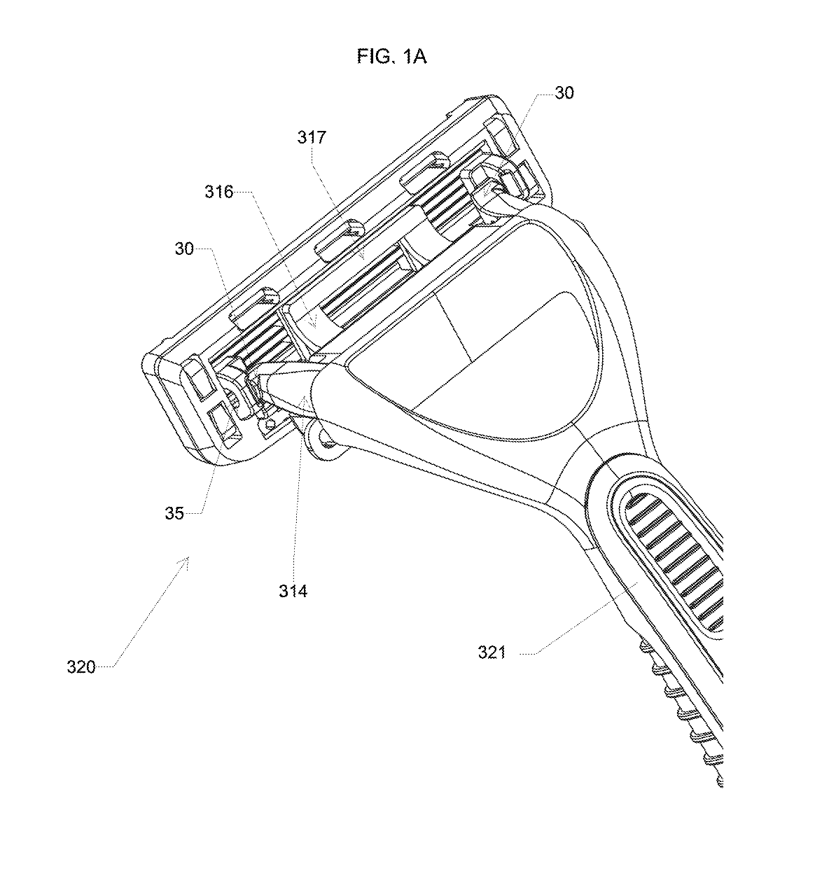

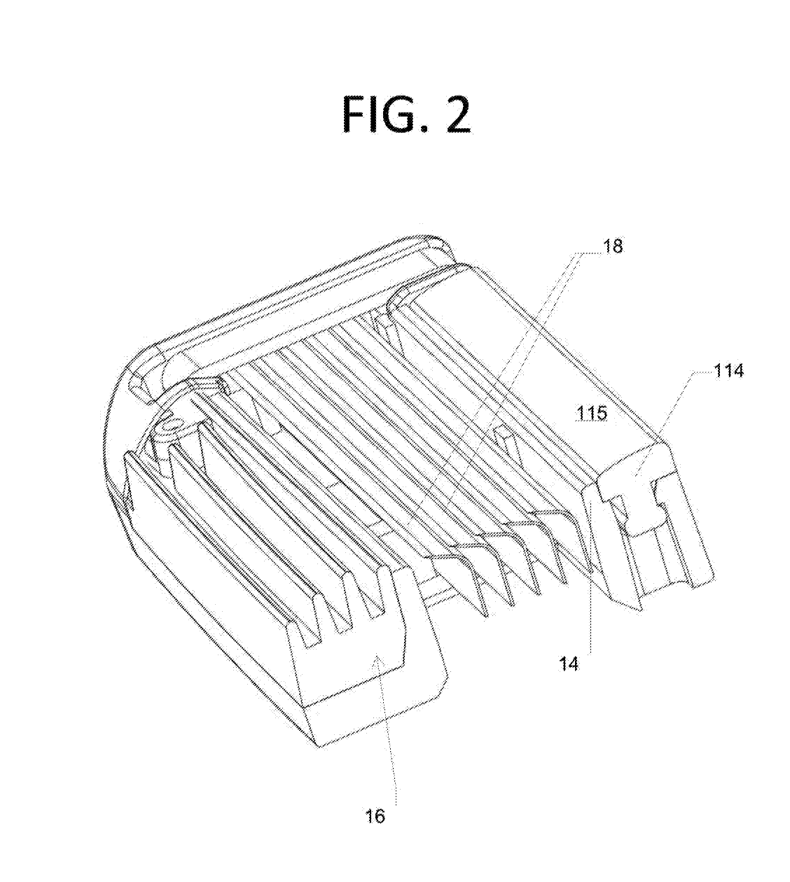

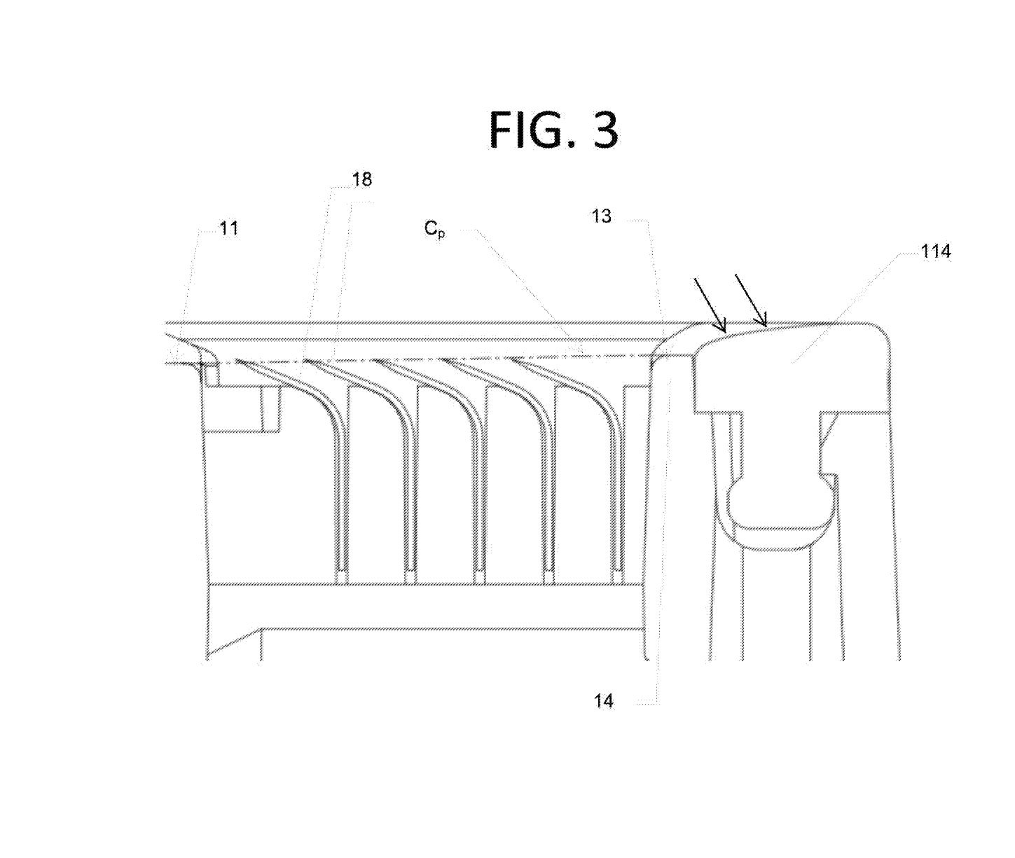

As shown in FIGS. 1-4, a razor cartridge 10 according to one implementation includes a housing 12, a cap 14 (FIG. 2), a guard 16, and a plurality of blades 18 disposed between the cap and guard. The guard may be a composite guard, as described in U.S. Application No. 61/983,790, filed Apr. 24, 2014, the full disclosure of which is incorporated herein by reference. The housing 12 defines a generally rectangular frame surrounding an open area in which the blades 18 are positioned. As shown in FIG. 3, the housing also defines a leading guard surface 11 and a trailing cap surface 13, which together define a contact plane Cₚ.

As shown in FIG. 1A, the razor cartridge 10 may be used in a shaving assembly 320, disposed on a razor handle 321. The shaving assembly 320 includes an interface element 314 that allows the cartridge to be mounted on the handle, and that provides pivoting of the cartridge during shaving. The cartridge is mounted on the interface element 314 by the positioning of a pair of fingers 30 which extend from the interface element into receiving bores 35 on the blade unit. A return element 316 provides a return force during shaving. Details of this arrangement are disclosed in U.S. patent application Ser. No. 13/802,614, the full disclosure of which is incorporated herein by reference.

The razor cartridge 10 preferably includes a number of features that contribute to enhanced skin management and thus to a close, comfortable shave, as described in U.S. Provisional Application No. 62/023,419, filed Jul. 11, 2014, the full disclosure of which is incorporated herein by reference. For example, as shown in FIG. 3, the blade exposure goes from slightly positive closest to the guard, to slightly negative closest to the cap.

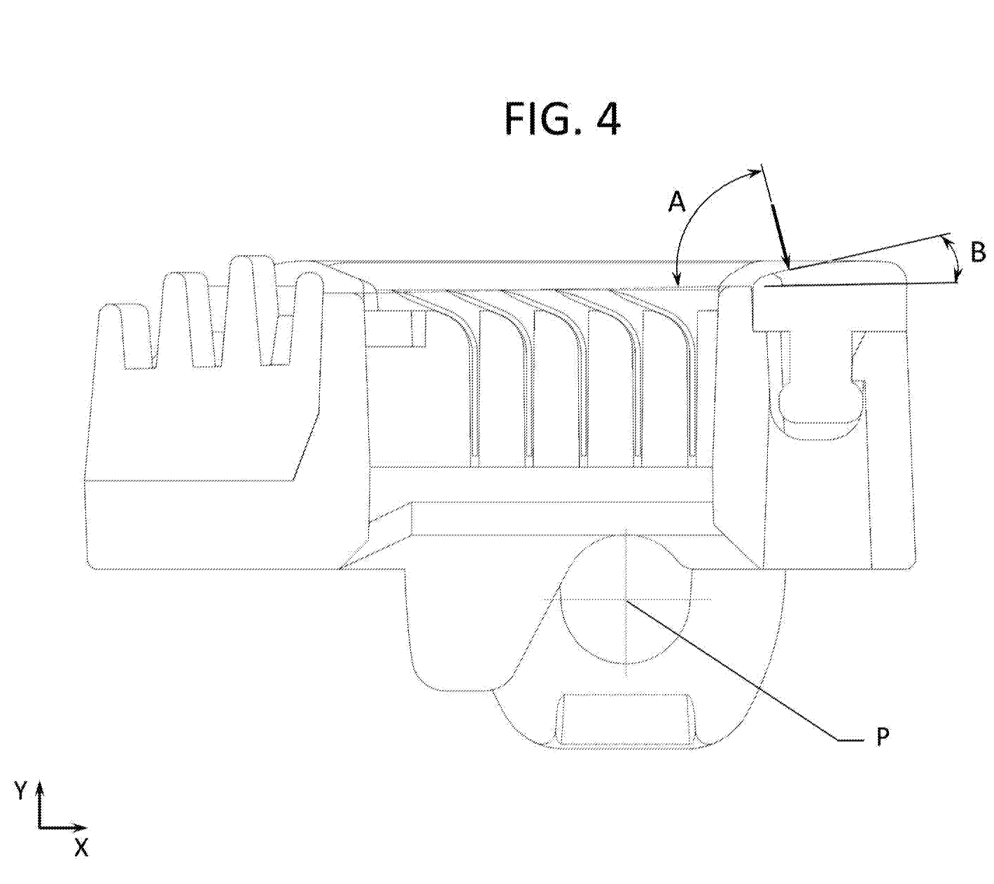

The cartridge is designed to pivot in a manner that causes shaving forces to be relatively evenly distributed over the blades during shaving, with somewhat less force being applied to the primary blade. By applying more force to the negative and neutral blades and less to the primary blade, shaving comfort is enhanced without deleteriously affecting closeness. Referring to FIG. 4, in preferred implementations the pivot axis P of the cartridge is positioned closer to the cap trailing edge than to the guard leading edge, measured along the x axis, and below the bases of the blades, measured along the y axis. This arrangement, known as “rear pivoting,” reduces the likelihood of nicking due to the positive exposure of the primary blade, especially during clean up strokes, and spreads blade wear relatively evenly between the blades. The rear pivoting arrangement also helps to prevent nicking by the positively exposed primary blade. The combination of this rear pivoting arrangement with the geometry of the lubricating strip, which will be discussed below, maintains contact between the skin bulge and the trailing cap surface over the life of the cartridge.

Mounted on the housing, adjacent to the cap 14, is a lubricating strip 114 having an angled upper surface 115 (FIG. 2). Lubricating strip 114 includes a matrix of a water-insoluble or biodegradable polymer containing a water-soluble shaving aid, for example a lubricant, e.g., polyethylene oxide, or other additive or adjuvant useful in wet shaving systems. The polymer matrix gradually erodes with each razor stroke and the shaving aid leaches out of the matrix, providing lubricant to the skin of the user throughout the operational life of the razor.

The contact between the user's skin and the cap 14 helps to keep the skin in tension during shaving, which in turn helps to position the skin onto the contact plane. The geometry of the lubricating strip 114, the upper surface of which is angled relative to the contact plane and which extends above the contact plane, helps to maintain this contact between the skin and the cap during the intended lifespan of the cartridge. The angle of the leading portion of the lubricating strip relative to the cutting plane extends the number of shaves that can occur before the trailing portion of the lubricating strip wears down to form an acute angle with the contact plane (i.e., the trailing edge of the lubricating strip becomes lower than the contact plane of the blades), at which point this contact between the skin and the cap is generally lost.

Due to the positive blade exposure of the primary blade and the rear pivoting arrangement of the cartridge, shaving can become too aggressive if the lubricating strip wears down to a negative angle, such that the user's skin is no longer being urged against the cap by the lubricating strip. To address this problem, the upper surface 115 of the lubricating strip 114 is initially (prior to the first use of the cartridge) disposed at an angle with respect to the contact plane, as discussed above, rather than being generally parallel to the contact plane). Because the surface 115 of the lubricating strip is at an angle with respect to the contact plane, the forces between the skin and the lubricating strip surface are at an acute angle with respect to the contact plane, as indicated by the arrows in FIG. 3, rather than perpendicular to the contact plane. In some implementations, the forces may be at an angle of about 30 to 90 degrees with respect to the contact plane (Angle A, FIG. 4). The initial (pre-use) angle of the lubricating strip surface with respect to the contact plane is preferably from about 0 to 45 degrees (Angle B, FIG. 4).

Thus, the forces applied by the skin against the lubricating strip 114 are oriented so that when the cartridge is loaded onto the skin the lubricating strip 114 urges the skin towards the cap 14, and the loading profile extends in a relatively uniform manner from the leading guard bar surface to the trailing cap surface. The lubricating strip continues to provide contact between the skin and the trailing cap surface until the strip has worn down to or past a point at which its surface is generally parallel to the contact plane. One of the benefits of this design is that as the lubricating strip swells or wears, the shaving geometry of the cartridge, as defined by the contact plane, remains substantially unaffected.

The angled surface of the lubricating strip also reduces drag during shaving, allowing a shaving assembly that includes the cartridge to be designed with a lower pivot return force while keeping the contact plane aligned with the skin surface. This lower pivot return force allows the shaving cartridge to adapt more easily to the surface being shaved which reduces the need for handle adjustments and allows the user to more easily manipulate the cartridge during shaving, enhancing the shaving experience.

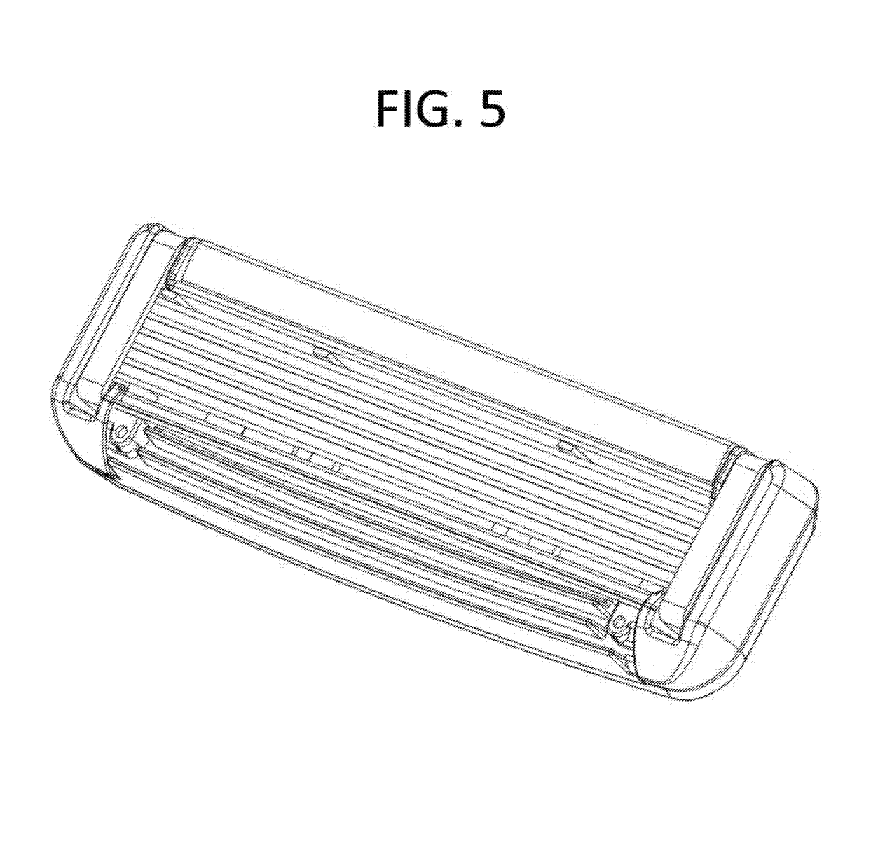

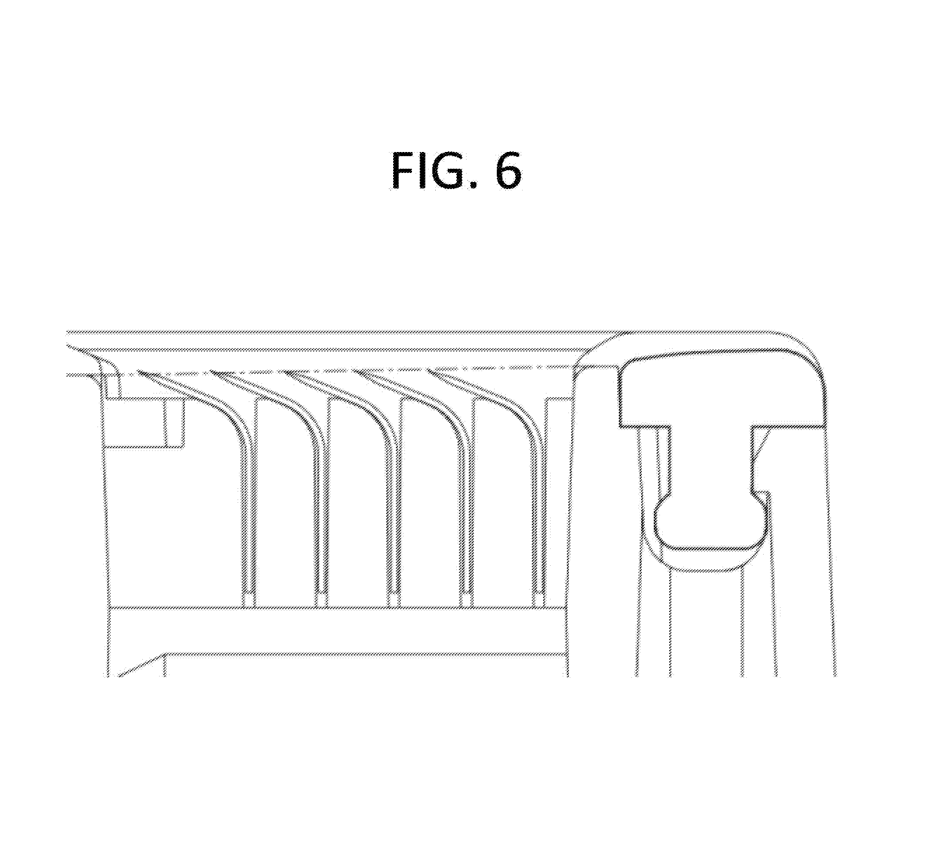

It is also preferred that the lubricating strip be sufficiently high, relative to the contact plane, so that contact between the skin and lubricating strip is maintained over the operating life of the cartridge. In some implementations, the height above the contact plane of the highest portion of the lubricating strip may be substantially equal to the height above the contact plane of the housing adjacent the lubricating strip, as shown in FIGS. 1-4. In other implementations, the height of the lubricating strip may be lower, e.g., the highest point on the lubricating strip may be about halfway between the contact plane and the highest point on the adjacent portion of the housing, as shown in FIGS. 5-6, or even lower, e.g., from about 25% to 50% of the height of the housing above the contact plane.

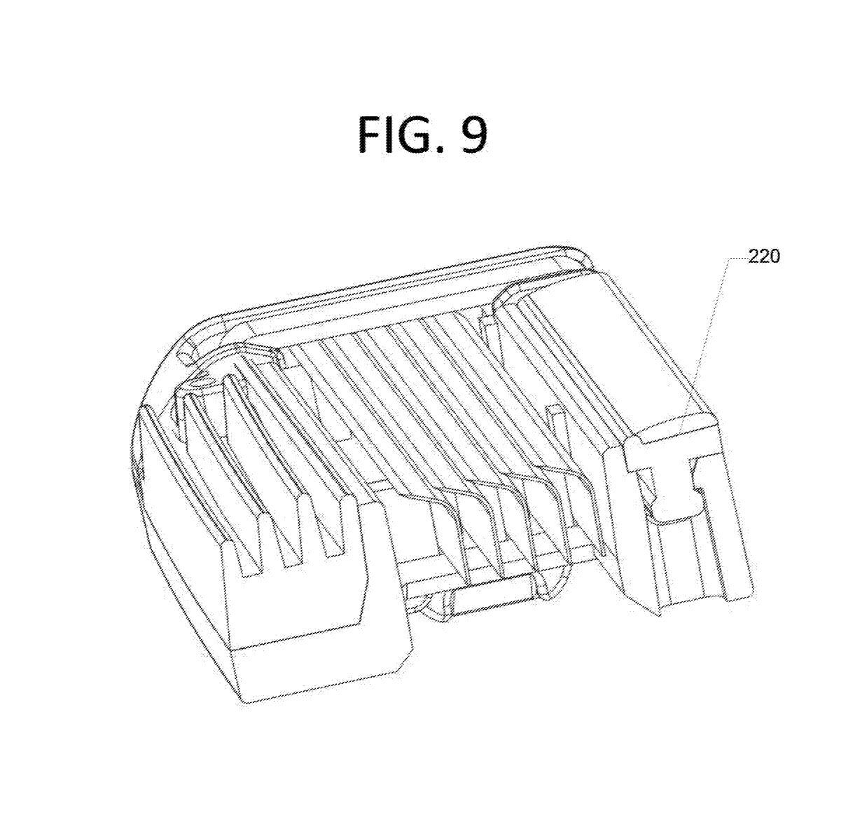

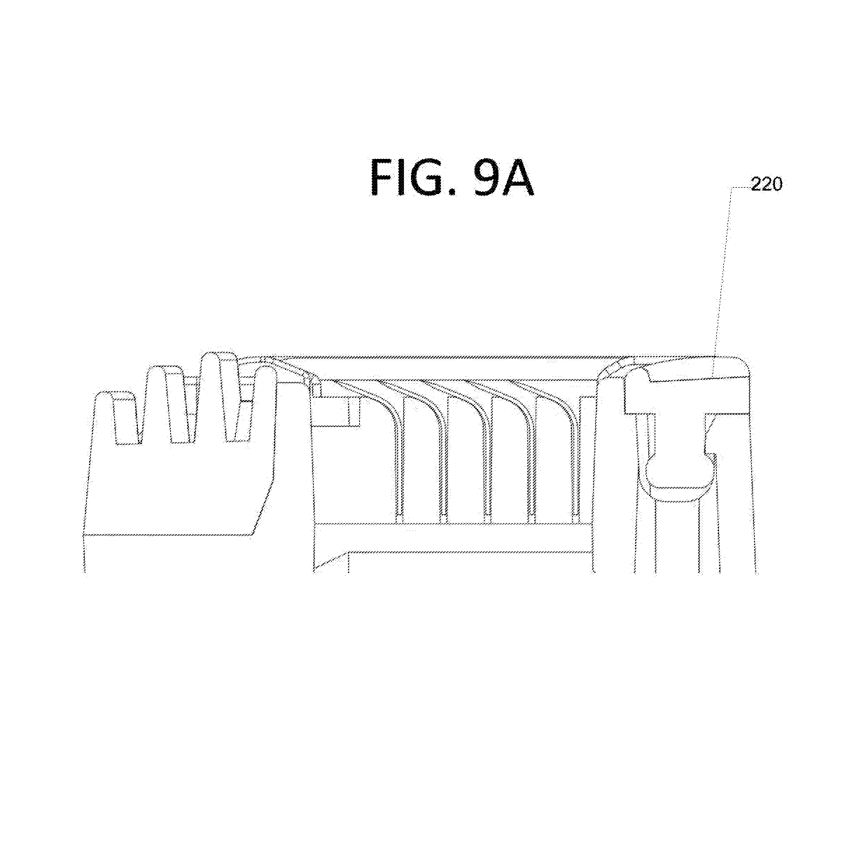

The lubricating strip 114 may include a wear indicator 220 (FIGS. 9-9A.) that is eroded when the lubricating strip has worn to an extent that will negatively impact user comfort. This indicator is generally positioned such that the underlying material, which is typically of a different color, is exposed when the lubricating strip has worn to a point that renders the effective blade geometry too aggressive for user comfort, at which point the blades may be worn to an extent that reduces shaving efficacy and comfort.

For example, a lower (indicating) surface of the wear indicator may be approximately level with the contact plane, as shown in FIGS. 9-9A. Alternatively, the lower surface may be coplanar with and slightly above the contact plane. In some implementations, the wear indicator comprises material having a different color from that of the lubricating strip, and a lower surface of the wear indicator is generally coplanar with or parallel to the contact plane. The wear indicator may extend only part way across the width of the lubricating strip, as shown, or may extend across the full width or have any other desired configuration.

In some cases, the wear indicator may have a different composition than the underlying lubricating strip body, so that the rate of erosion of the wear indicator material correlates with the rate of wear of the blades or other factors affecting user comfort and shaving efficacy. For example, the wear indicator material may include more of the water-soluble component (e.g., polyethylene oxide) than the lubricating strip body.

The composition of the lubricating strip (e.g., the wear resistance of the biodegradable polymer and/or the concentration of lubricant) is preferably selected so that the number of shaves at which the strip has eroded such that its upper surface is generally parallel to the contact plane generally coincides with the desired lifetime of the cartridge.

In some implementations, the lubricating strip includes from about 20% to about 50% by weight of the polymer matrix and from about 50% to about 80% by weight of the water-soluble shaving aid. Suitable polymers for the matrix include, for example, nylon, ethylene-vinyl acetate copolymer, polyethylene, polypropylene, polystyrene, polyacetyl and combinations. Suitable shaving aids include, for example, polyethylene oxide, polyvinyl pyrrolidone, polyacrylamide, hydroxypropyl cellulose, polyvinyl imidazoline, polyethylene glycol, polyvinyl alcohol, methylcellulose, starch, water soluble vinyl polymers (CARBOPOL® polymers sold by B.F. Goodrich), polyhydroxyethylmethacrylate, silicone copolymers, sucrose stearate, vitamin E, panthenol, aloe, essential oils such as methanol and combinations.

The housing 12 can be made of any suitable material including, for example, amorphous blends of polyphenylene ether and polystyrene, e.g., polymers sold under the tradename NORYL resins, acrylonitrile butadiene styrene (ABS), polystyrene, polyethylene terephthalate (PET or PETE), high density (HD) PETE, thermoplastic polymer, polypropylene, oriented polypropylene, polyurethane, polyvinyl chloride (PVC), polytetrafluoroethylene (PTFE), polyester, high-gloss polyester, nylon, or any combination thereof. The cap 14 is preferably formed of the same material as the housing, and is generally formed integrally with the housing.

The clips can be made of metals (preferably Aluminum, aluminum alloys) or other malleable material.

The guard, including the elastomeric portion of the composite guard, may be made of any suitable materials, e.g., as described in U.S. Application No. 61/983,790, filed Apr. 24, 2014.

A number of embodiments have been described. Nevertheless, it will be understood that various modifications may be made without departing from the spirit and scope of the disclosure.

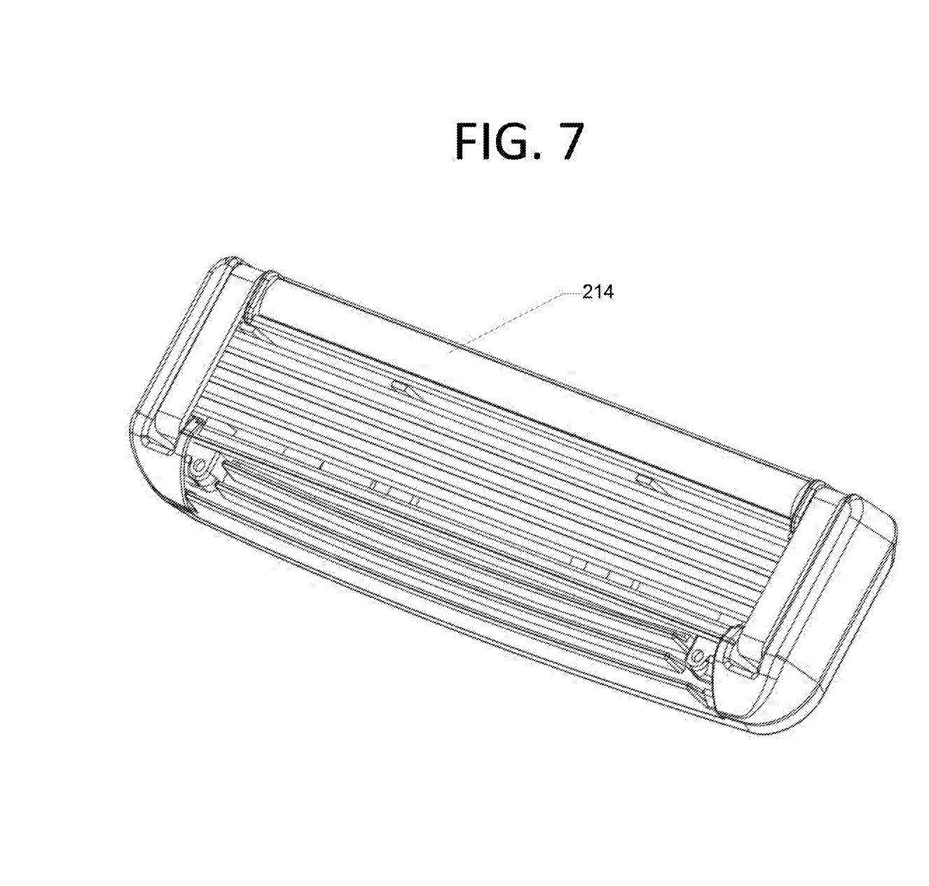

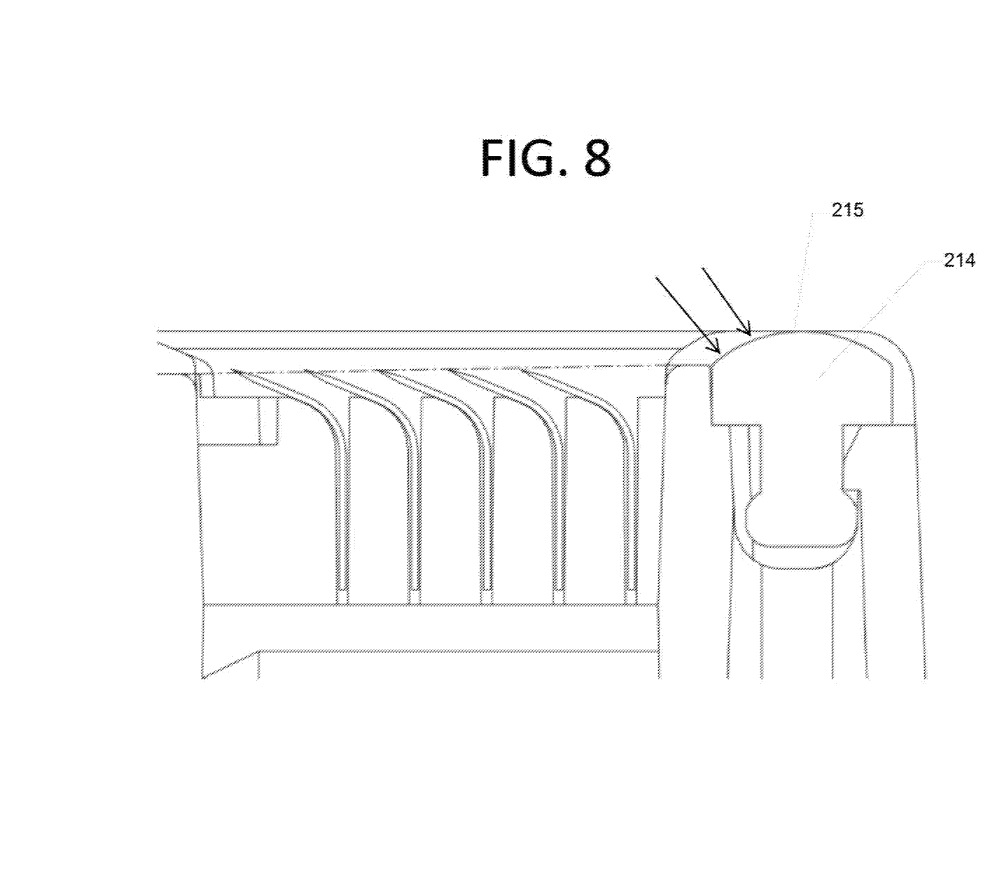

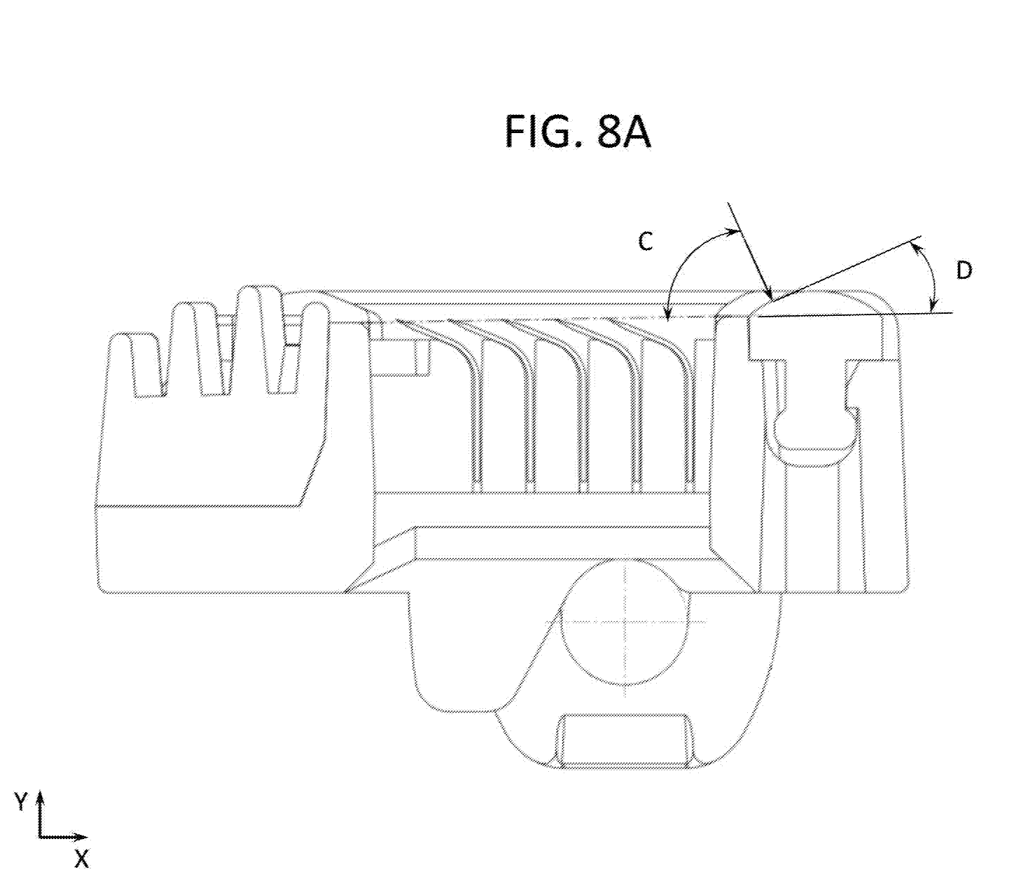

For example, the upper surface of the lubricating strip may have other shapes, so long as the forces between the skin and the lubricating strip are at an angle to the contact plane rather than perpendicular to the contact plane. One example of another suitable shape is shown in FIGS. 7-8. In this implementation, the upper surface 215 of the lubricating strip 214, in profile, is in the form of a generally symmetrical arc. As indicated by the arrows in FIG. 8, the forces applied by the skin to the surface 215 are oriented similar to the forces applied in the implementations discussed above. In some implementations, the forces may be at an angle of about 30 to 90 degrees with respect to the contact plane (Angle C, FIG. 8A). The initial (pre-use) angle of the lubricating strip surface with respect to the contact plane is preferably from about 0 to 45 degrees (Angle D, FIG. 8A).

In some implementations, the cartridge may have more or fewer than five blades. Moreover, the exposure of the blades other than the primary blade may in some implementations be different from the progression described above.

Moreover, while a generally rectangular cartridge is shown in the Figures, other shapes can be used, e.g., oval.

Accordingly, other embodiments are within the scope of the following claims.

What is claimed is:

1. A shaving assembly comprising:
an interface element configured to be mounted on a razor handle; and
pivotably mounted on the interface element, a razor cartridge, the razor cartridge comprising:
a frame defining a base, said frame having an opening defined in part by a composite guard having a leading guard surface and a cap having a trailing cap surface, said leading guard surface and said trailing cap surface cooperating to define a contact plane tangential thereto and extending across said opening;
a plurality of razor blades attached to said base; and
a lubricating strip mounted on the opposite side of the cap from the blades, the lubricating strip being configured so that contact is maintained between the user's skin and the trailing cap surface until the lubricating strip has worn to an extent that a trailing edge of the lubricating strip is positioned below the contact plane.

2. The shaving assembly of claim 1 wherein the lubricating strip has an upper surface that extends at an angle with respect to the contact plane.

3. The shaving assembly of claim 1 wherein said upper surface extends above the contact plane.

4. The shaving assembly of claim 1 wherein the cartridge has a pivot point that is closer to the trailing cap surface than to the leading guard surface.

5. The shaving assembly of claim 1 wherein an upper surface of the lubricating strip is disposed at an angle with respect to the contact plane such that the forces between the skin and the lubricating strip surface are at an acute angle with respect to the contact plane.

6. The shaving assembly of claim 5 wherein the lubricating strip is configured such that the forces are at an angle of about 30 to 90 degrees with respect to the contact plane.

7. The shaving assembly of claim 1 wherein an initial (pre-use) angle of the lubricating strip surface with respect to the contact plane is preferably from about 0 to 45 degrees.

8. The shaving assembly of claim 1 wherein an upper surface of the lubricating strip is curved.

9. The shaving assembly of claim 1 wherein the profile of an upper surface of the lubricating strip is in the form of a generally symmetrical arc.

10. The shaving assembly of claim 1 wherein the height above the contact plane of the highest portion of the lubricating strip is at least 25% of the height above the contact plane of the housing adjacent the lubricating strip.

11. The shaving assembly of claim 10 wherein the height above the contact plane of the highest portion of the lubricating strip is at least 50% of the height above the contact plane of the housing adjacent the lubricating strip.

12. The shaving assembly of claim 10 wherein the height above the contact plane of the highest portion of the lubricating strip is substantially equal to the height above the contact plane of the housing adjacent the lubricating strip

13. The shaving assembly of claim 1 further comprising a wear indicator positioned within the lubricating strip.

14. The shaving assembly of claim 13 wherein the wear indicator comprises material having a different color or composition from that of the lubricating strip.

15. The shaving assembly of claim 12 wherein an upper surface of the wear indicator is generally coplanar with or parallel to the contact plane.

16. A razor comprising:
a handle having a distal end;
an interface element configured to be mounted on the distal end of the handle; and
pivotably mounted on the interface element, a razor cartridge, the razor cartridge comprising:
a frame defining a base, said frame having an opening defined in part by a composite guard having a leading guard surface and a cap having a trailing cap surface, said leading guard surface and said trailing cap surface cooperating to define a contact plane tangential thereto and extending across said opening;
a plurality of razor blades attached to said base; and
a lubricating strip mounted on the opposite side of the cap from the blades, the lubricating strip being configured so that contact is maintained between the user's skin and the trailing cap surface until the lubricating strip has worn to an extent that a trailing edge of the lubricating strip is positioned below the contact plane.
